(19) United States
(12) Patent Application Publication
(10) Pub. No.: US 2014/0041125 A1
(43) Pub. Date: Feb. 13, 2014

(54) TRI-CELL LUMBER SUPPORT TRAVEL PILLOW

(71) Applicant: S. M. Grealy, Christies Beach (AU)

(72) Inventor: S. M. Grealy, Christies Beach (AU)

(21) Appl. No.: 14/113,618

(22) PCT Filed: May 1, 2012
(86) PCT No.: PCT/AU2012/000452

§ 371 Date: Oct. 24, 2013

(30) Foreign Application Priority Data
May 6, 2011 (AU) 2011901677
Dec. 23, 2011 (AU) 2011101697

(51) Int. Cl. A47G 9/10; B60N 3/06

(52) U.S. Cl. CPC A47G 9/1027; B60N 3/06
USPC 5/655.3

(57) ABSTRACT

The present invention relates to a portable self-contained inflatable pillow comprising two or three separate cells attached laterally to each other. Each cell has its own hermetically sealed nipple for individual inflation. The cell inflation can be via mechanical means using a hand pump or orally. The pillow can be used for lumbar support, leg support or as a foot rest, and can be deflated entirely for flat packing.

### FIELD OF THE INVENTION

The present invention relates to an inflatable pillow for lumbar support. In particular, the invention provides a comfortable pillow for travellers on medium to long haul flights that is cheap to manufacture and has the versatility and adaptability to conform to the needs of travellers of any shape and size, and on various seat types. The pillow could be used during other forms of travel such as train, bus or car. Additionally, the pillow could be used for leg and/or foot support of a traveller.

### BACKGROUND OF THE INVENTION

One of the most stressful and debilitating forms of travel is in the coach or economy-class airline seat. Sitting for long periods is an unnatural thing to do. There are more muscles used to maintain good posture sitting than standing. The neck and back, specifically the lumbar region, are often found to be exceptionally painful after long time seated travel. The reason for this is that travellers will typically slump, slip, slide or slouch into their seat, losing good posture, and thereby allowing the lumbar region unsupported for extended periods of time.

Lordosis is the term used to describe the natural inward curvature of the lower back. When a person stretches out and slouches in a chair, the natural inward curvature is altered and the lower back often drops or curves outward. Lumbar support pillows which seek to prevent this from occurring are widely available in various designs, sizes, shapes and materials to relieve discomfort, cramps and pain. Some are traditional, generally rectangular shapes being similar in design to a standard sleeping pillow. Others range from circular to wedge shaped. They are invariably used any time a person is confined to a seated position for any length of time, be it at a desk or travelling by any form of transport.

Lumbar support pillows are generally divided into two types being either a “solid” pillow which is filled with soft product, or inflatable. Many of the solid non-inflatable lumbar support pillows are suited to travelling by car, bus or train because despite their inherent size they do not pose a packing problem for those with the luxury of luggage space. Due to the space constrictions, the inflatable pillow is the preferred option for air travel in that such pillows are able to be deflated and packed away flat. Currently some medium to long haul airline passengers are issued a small pillow filled with soft product. While such pillows are useful as head pillows, they are far too soft to provide any real solid lumbar support.

Nearly all airline seats will have some degree of ‘back seat recline’. This clearly allows the head to assume a more comfortable sleeping angle and consequently dispels at least some of the discomfort of travel over an extended period of time. The propensity for the traveller to want to stretch out their legs and assume as best as possible a fully reclined position is restricted by both the limit of their own backrest recline movement and the close proximity of the seat in front of them. However the fact remains that most will attempt to ‘stretch out’ to give relief to their legs and allow their head a more natural sleeping position, particularly when a neck support pillow is used.

Medium to long haul travellers will almost always want to sleep for some of the trip. When sleep begins and attention to posture in the chair declines, the seated person often begins to slump in the chair and the result is a back ache. Research has shown that the unsupported lumbar zone created during the ‘stretched out’ period of cramped air travel is generally a triangular shaped space defined between the seat base, the seat backrest and the traveller's lumbar region. To this end there are a number of triangular and wedge shaped pillows both stuffed solid and inflatable which are marketed to address this issue.

The lumbar area is not the only body zone to find discomfort during air travel. Any bodily area will suffers from lack of movement as the reduced blood flow causes aggravation. Having the use of an inflatable foot rest can markedly reduce the pain of DVT (Deep Vein Thrombosis) by offering the user a variety of different positions to place their feet to assist in blood flow. Larger sized passengers can find themselves already too cramped to stretch out. They are obliged to stay awake, maintaining their posture, sitting well back in the seat to save their knees from impacting on the seat back in front of them. [008] The consistent failing of currently available inflatable pillows, specifically for air travel lumbar support, is that they are ‘one size fits all’. Even allowing for variation in inflation volume and subsequent ‘crush resistance’ they still fail to address not only the variety of different shaped/sized airline seats, but also the requirements of the different sized traveller, particularly with their ever shifting and changing quest to maintain comfort.

It is therefore an object of the present invention to overcome at least some of the aforementioned problems or to provide the public with a useful alternative.

### SUMMARY OF THE INVENTION

Therefore in one form of the invention there is proposed a portable self-contained inflatable pillow for use as a lumbar support or foot rest during extended seated travel, said pillow characterised by:
at least two individual cells which are individually sealed and individually inflatable to a pressure up to a maximum pressure allowable for each cell; and
wherein each of the at least two cells includes two substantially planar surfaces and an outer perimeter edge which is disposed inwards of the two planar surfaces when the cell is at least partially inflated, whereby each cell is attachable to another cell along their planar surfaces and the size of the planar surfaces of consecutive cells are of a stepped dimension along at least one axis.

Preferably the cells are attached such that the bottom and side edges are aligned and their top edges are of a consecutive, stepped-down height dimension.

In preference said pillow includes three individual cells each having substantially rectangular planar surfaces such that the outer perimeter edge of each cell includes a top and bottom edge and two side edges.

Preferably a first cell of greatest height is attached to a second cell of medium height which is attached to a third cell of least height, said cells being configured to form a substantially right-angled triangle side profile when at least two of the cells are inflated or partially inflated.

In preference said pillow is sized to provide lumbar support to a user while seated such that the substantially right-angled triangle side profile fits a profile formed between a horizontal and vertical portion of said seat and an unsupported, diagonally extending lumbar portion of a user's back.

In preference said pillow is sized to provide additional seat base support and comfort for the user while seated. For example, by placing the pillow onto their seat base with only the smallest cell inflated, they will change the angle of the seat base thereby lifting their legs up to an otherwise unobtainable level. Lifting the legs up at the knee end drives the lumbar back into the seat back support zone, as well as potentially lifting their feet to a more comfortable position possibly incorporating the inflatable foot rest.

In preference said pillow is sized to provide a foot rest to a user while seated.

Preferably said cells are manufactured from a polyvinylchloride (PVC) material.

In preference said cells are attached along their planar surfaces using one or more attachment means.

In preference said attachment means is PVC welding.

Alternatively said attachment means is adhesive.

Alternatively still, said attachment means is one or more hook and loop fasteners.

Preferably each cell includes its own outlet and associated nipple to facilitate inflation and deflation.

In a further form of the invention there is proposed a portable self-contained inflatable pillow for use as a lumbar support or foot rest during extended seated travel, said pillow characterised by:
three individual cells each having substantially rectangular planar surfaces such that an outer perimeter edge of each cell includes a top and bottom edge and two side edges, each cell being individually sealed and individually inflatable to a pressure up to a maximum pressure allowable for each cell, and wherein a first cell of greatest height is attached to a second cell of medium height which is attached to a third cell of least height, said cells being configured to form a substantially right-angled triangle side cross sectional profile when at least two of the three cells are inflated or partially inflated; and
wherein the edge of each cell is disposed inwards of the two planar surfaces when the cell is at least partially inflated and each cell is attachable to another cell along their planar surfaces.

### BRIEF DESCRIPTION OF THE DRAWING FIGURES

The accompanying drawings, which are incorporated in and constitute a part of this specification, illustrate several implementations of the invention and, together with the description, serve to explain the advantages and principles of the invention. In the drawings:

FIG. 1 is a perspective view of a tri-celled pillow configured in accordance with an embodiment of the present invention, with the base set fully inflated, the centre set fully deflated, and top set fully inflated;

FIG. 2 is a perspective view of the tri-celled pillow of FIG. 1 with the base set fully inflated, the centre set partially inflated, and the top set fully inflated;

FIG. 3 is a perspective view of the tri-celled pillow of FIG. 1 with the base set, centre set and top set all fully inflated;

FIG. 4 is a side view of the pillow configuration shown in FIG. 1;

FIG. 5 is a side view of the tri-celled pillow of FIG. 1 when the base set, centre set and top set are all fully deflated;

FIG. 6 is a side profile view of an air traveller in a fully reclined airline seat showing vacant unsupported lumbar space caused by stretching out in the seat;

FIG. 7 is a side profile view of an air traveller in a fully reclined airline seat using the tri-celled pillow of FIG. 1;

FIG. 8a is a side profile view of a traveller's feet and a tri-celled pillow of FIG. 1 when used as a footrest in an inverted configuration;

FIG. 8b is a side profile view of a traveller's feet and a tri-celled pillow of FIG. 1 when used as a footrest in a flat configuration;

FIG. 9 is a side view of a bulb/hand pump which can be used to inflate the pillow of FIG. 1; and

FIG. 10 is a side profile view of a traveller's legs and a tri-celled pillow of FIG. 1 when used as an under leg support in a single cell configuration.

### DETAILED DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the embodiments and the following description to refer to the same and like parts.

The present invention relates to an inflatable lumbar/foot support travel pillow 10 adapted to provide a user with a simple cheap and flat packaged pillow that is adjustable to fit nearly any sized person who is travelling for any distance. While the present invention is intended for use in economy-class airline seats, it could equally well be used in any other seat and any other travelling scenario.

An important feature of the invention is that the pillow 10 includes multiple cells which are each independently inflatable, allowing a user to inflate any one or more of the cells in any combination to suit a particular travel experience. In a preferred embodiment, the pillow is tri-celled having three separate air cells 12, 14 and 16, herein referred to as the base set 12, the centre set 14, and top set 16, that can be individually inflated to offer a plurality of different pillow configurations for lumbar support and two different pillow positions as a foot rest.

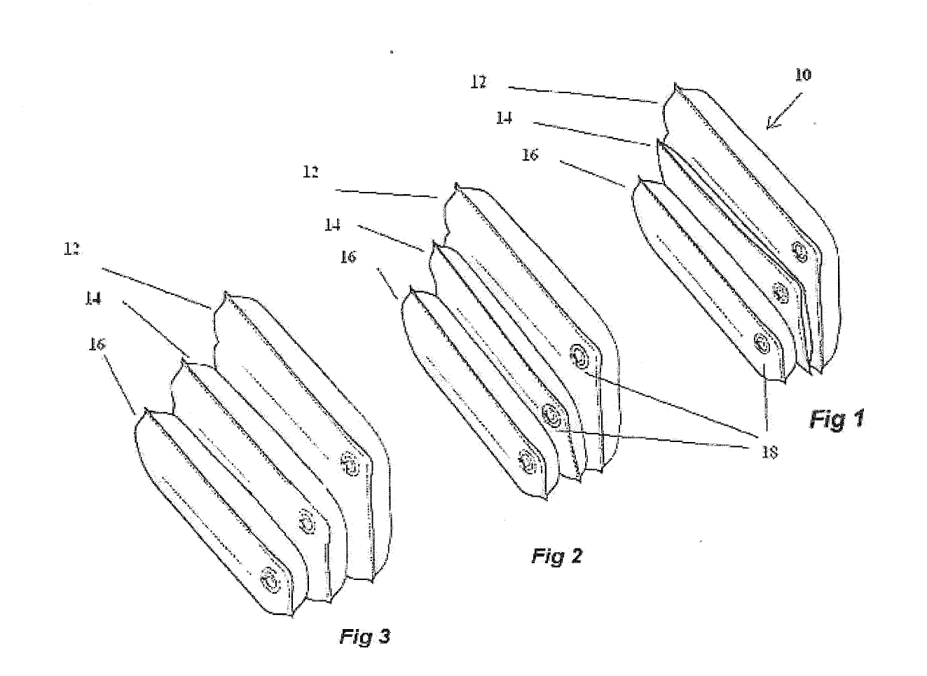

Each cell is hermetically sealed and inflatable via inflation nipples 18 associated with each cell. The tri-celled pillow 10 can be viewed in various different inflated configurations in FIGS. 1 to 5. The skilled addressee would appreciate that not all the possible configurations are shown in the drawings. A user could choose to inflate or partially inflate one cell, two cells, or all three cells, to whatever level of pressure they desire (within the confines of its maximum operating pressure).

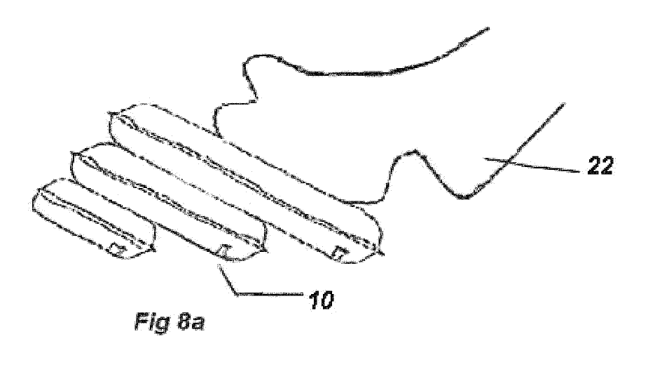

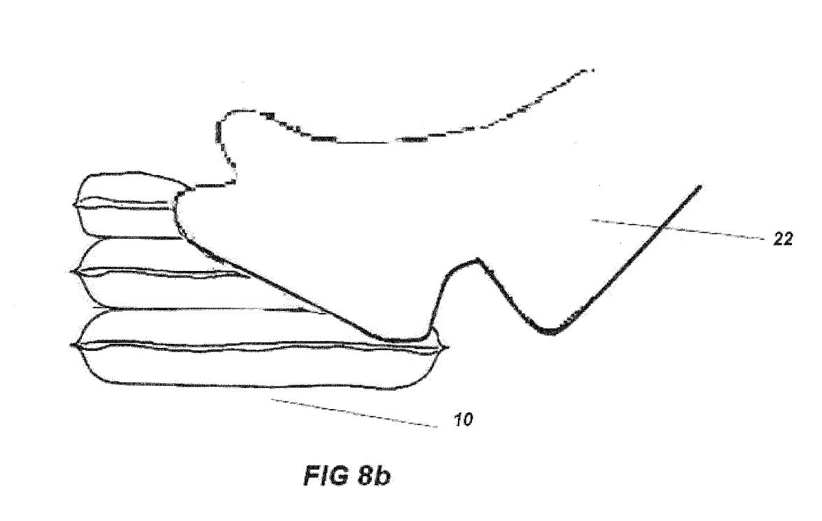

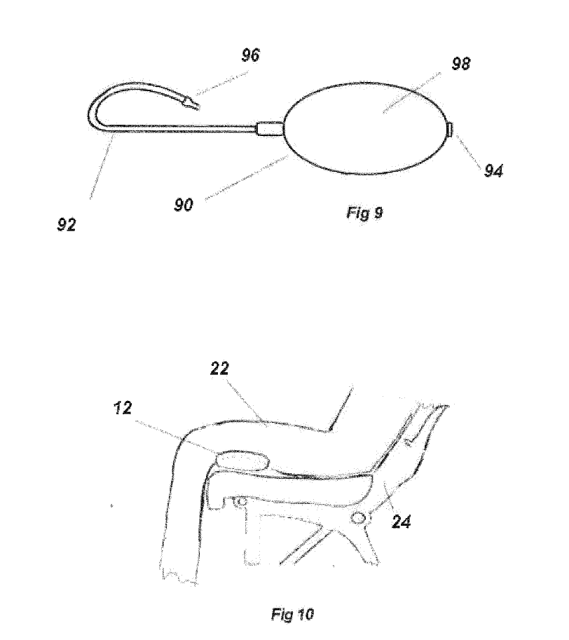

It is envisaged that all three cells would be inflated when the pillow 10 is used as a foot rest as shown in two different configurations in FIGS. 8a and 8b. As shown, the fully inflated pillow can be placed on the floor in two ways to provide different angles depending on the user's needs.

The base set 12 is rectangular being approximately 300 mm in height, approximately 360 mm in width, and 50 mm to 75 mm deep. The centre set 14 is rectangular being approximately 200 mm in height and the same width and depth as the base set. The top set 16 is rectangular being approximately 130 mm in height with the same width and depth dimensions as the other cells. Therefore, in accordance with this preferred embodiment, the cell edges align along their base and side edges, but have a stepped-down height configuration as shown in the drawing such that when placed on a flat surface and fully inflated they form a substantially right angle triangle side profile.

The base set 12 is attached to the centre set 14 which in turn is attached to the top set 16 in a stacked formation to give (when fully inflated and viewed in-place ready to use) a wedge shaped pillow with a right angle triangle side profile.

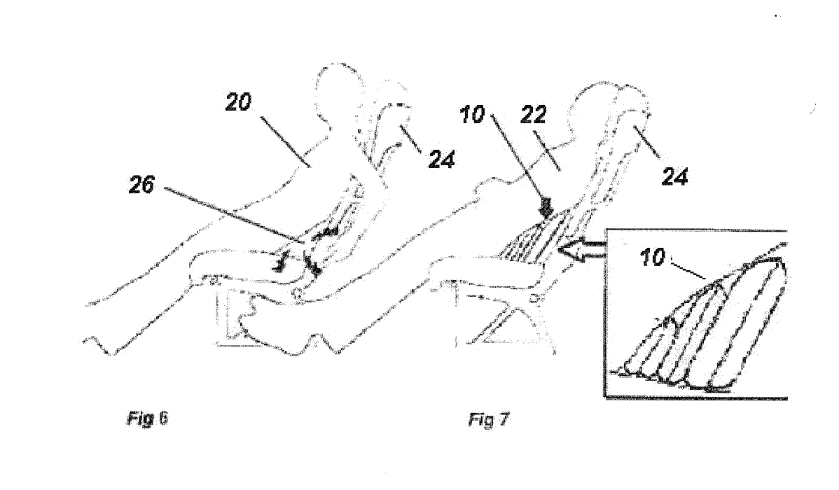

FIG. 6 shows a person 20 seated in a fully reclined airline seat 24 with no lumbar support in the region 26. FIG. 7 shows an air traveller 22 in the same seat 24 having full lumbar support provided by the pillow 10 of the present invention. The right angle triangle side profile can be appreciated in this view. As shown, the dangerous outward curvature of the back shown in FIG. 6 is prevented through use of the pillow 10.

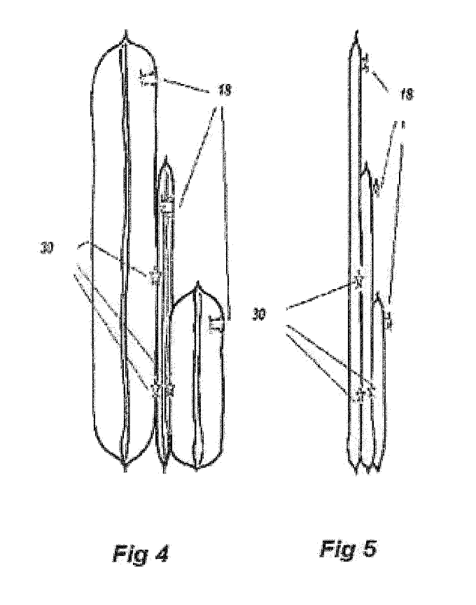

The preferred method of attachment of the individual sets 12, 14 and 16 will occur as part of the manufacturing plastic welding process. Other methods of attachment may include double-sided tape, Velcro®, glue or other methods as may become appropriate. FIGS. 4 and 5 show the positions of lateral bonding lines 30 along which the three cells are attached together according to a preferred embodiment. It can be appreciated that each cell includes a perimeter edge that is disposed inwards of outer faces of the cell when the cell is at least partially inflated, the outer faces being the preferred area of attachment between cells. However, it is to be understood that the three cells could equally well be attached at different positions, for example, along the base edge of each cell. This may provide even further possible shape configurations in that each cell may be connected to one another to allow for relative rotation between adjacent cells.

It is to be further understood that the present invention need not necessarily be limited to the use of three cells, but could equally well include two cells for example shaped to provide the same lumbar and foot support as the pillow embodied herein. The important feature for lumbar support is the triangular side profile shape resulting from the inflation, partial inflation, or even deflation of one or more of a plurality of cells.

The method of inflating each cell is not intended to be limiting either, for example, one may simply blow up each cell using their breath, or one could use an inflation device such as that shown in FIG. 9. The device includes a tube, an intake valve 94, a connector 94 for attachment to nipple 18, and a bulb/hand pump body 98 adapted to be continuously pressed to draw air from the outside through the tube and into the cell.

In summary the pillow 10 offers two or three or more individual air cells within the one inflatable pillow providing up to twelve or more different shaped pillows and an infinite variation of user adaptability by virtue of the inflation pressure within those shapes. Also provided are at least two different foot rest configurations, making the pillow an ideal source of comfort and back support during extended travel.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

In any claims that follow and in the summary of the invention, except where the context requires otherwise due to express language or necessary implication, the word “comprising” is used in the sense of “including”, i.e. the features specified may be associated with further features in various embodiments of the invention.

1-20. (canceled)

21. A portable self-contained inflatable pillow for use as a lumbar support or foot rest during extended seated travel, said pillow comprising:
at least two individual cells which are individually sealed and individually inflatable to a pressure up to a maximum pressure allowable for each of said cells respectively; and
wherein each of said at least two cells includes two substantially planar surfaces and an outer perimeter edge disposed inwards of said two planar surfaces when said cells are at least partially inflated respectively, whereby each of said cells is attachable to another cell along said planar surfaces and a size of said planar surfaces of consecutive cells are of a stepped dimension along at least one axis.

22. The portable self-contained pillow as claimed in claim 21, wherein said cells are attached such that a bottom and side edges of said perimeter edge are aligned and top edges are of a consecutive, stepped-down height dimension.

23. The portable self-contained pillow as claimed in claim 21, wherein said at least two cells is at least three cells each having substantially rectangular planar surfaces such that said outer perimeter edge of each of said cells includes a top and bottom edge and two side edges.

24. The portable self-contained pillow as claimed in claim 23, wherein a first cell of greatest height of said cells is attached to a second cell of medium height of said cells which is attached to a third cell of least height of said cells, said cells being configured to form a substantially right-angled triangle side profile when at least two of said cells are inflated or partially inflated.

25. The portable self-contained pillow as claimed in claim 24, wherein said pillow is sized to provide lumbar support to a user while seated such that said substantially right-angled triangle side profile fits a profile formed between a horizontal and vertical portion of a seat and an unsupported, diagonally extending lumbar portion of a user's back.

26. The portable self-contained pillow as claimed in claim 21, wherein said pillow is sized to provide seat base support to a user while seated when said pillow is located between a seat base and a leg of the user.

27. The portable self-contained pillow as claimed in claim 21, wherein said pillow is sized to provide a foot rest to a user while seated.

28. The portable self-contained pillow as claimed in claim 21, wherein said cells are manufactured from a polyvinylchloride (PVC) material.

29. The portable self-contained pillow as claimed in claim 21, wherein said cells are attached along said planar surfaces respectively using one or more attachment means.

30. The portable self-contained pillow as claimed in claim 29, wherein said attachment means is PVC welding.

31. The portable self-contained pillow as claimed in claim 29, wherein said attachment means is adhesive.

32. The portable self-contained pillow as claimed in claim 29, wherein said attachment means is one or more hook and loop fasteners.

33. The portable self-contained pillow as claimed in claim 21, wherein each of said cells includes an outlet and associated nipple for inflation and deflation.

34. A portable self-contained inflatable pillow for use as a lumbar support or foot rest during extended seated travel, said pillow comprising:
at least three individual cells each having substantially rectangular planar surfaces such that an outer perimeter edge of each of said cells includes a top and bottom edge and two side edges, each of said cells being individually sealed and individually inflatable to a pressure up to a maximum pressure allowable for each of said cells respectively; and
wherein a first cell of greatest height of said cells is attached to a second cell of medium height of said cells which is attached to a third cell of least height of said cells, said cells being configured to form a substantially right-angled triangle side cross sectional profile when at least two of said at least three cells are inflated or partially inflated;
wherein said outer perimeter edge of each of said cells is disposed inwards of said two planar surfaces respectively when the cell is at least partially inflated and each of said cells is attachable to another cell along said planar surfaces respectively.

35. The portable self-contained pillow as claimed in claim 34, wherein said cells are attached such that said bottom and side edges are aligned and said top edges are of a consecutive, stepped-down height dimension.

36. The portable self-contained pillow as claimed in claim 34, wherein said cells are manufactured from a polyvinylchloride (PVC) material.

37. The portable self-contained pillow as claimed in claim 34, wherein said cells are attached along said planar surfaces using one or more attachment means.

38. The portable self-contained pillow as claimed in claim 37, wherein said attachment means is PVC welding.

39. The portable self-contained pillow as claimed in claim 37, wherein said attachment means is adhesive.

40. The portable self-contained pillow as claimed in claim 37, wherein said attachment means is one or more hook and loop fasteners.
